(19) United States
(12) Patent Application Publication
(10) Pub. No.: US 2017/0255666 A1
(43) Pub. Date: Sep. 7, 2017

(54) VERIFYING FILE SYSTEM SNAPSHOTS

(71) Applicant: International Business Machines Corporation, Armonk, NY (US)

(72) Inventors: Erik Rueger, Ockenheim (DE); Christof Schmitt, Tucson, AZ (US)

(21) Appl. No.: 15/059,632

(22) Filed: Mar. 3, 2016

(51) Int. Cl. G06F 17/30; G06F 21/64

(52) U.S. Cl. CPC G06F 17/30371; G06F 17/30088; G06F 21/64

(57) ABSTRACT

A method includes receiving a snapshot comprising one or more files, calculating one or more file checksums for the files in the snapshot, creating a listing of elements in the snapshot, calculating a listing checksum corresponding to the listing of elements in the snapshot, comparing the one or more file checksums and the listing checksum of the received snapshot to one or more file checksums and listing checksums of an unverified snapshot responsive to receiving a snapshot verification request, and providing an indication that the snapshot is valid responsive to determining the one or more file checksums and the listing checksum of the received snapshot and the one or more file checksums and listing checksums of an unverified snapshot are the same. A computer program product and a computer system corresponding to the method are also disclosed.

### BACKGROUND OF THE INVENTION

The present invention relates generally to the field of filesystem management, and more specifically to verifying the snapshot integrity of a file system.

Full backups of large sets of data can take a long time to complete. On some multi-tasking systems, data may be updated while it is being backed up, which can create a version skew that may result in data corruption. Many filesystems have the capability of taking a snapshot of a current state of the filesystem. A snapshot is a read-only copy of a dataset or a storage device corresponding to a specific point in time. Snapshots are preserved and can be accessed independently of changes made later to the files to which the snapshots correspond. Snapshots can play an important role in a backup operation on a filesystem.

### SUMMARY

As disclosed herein, a method includes receiving a snapshot comprising one or more files, calculating one or more file checksums for the files in the snapshot, creating a listing of elements in the snapshot, calculating a listing checksum corresponding to the listing of elements in the snapshot, comparing the one or more file checksums and the listing checksum of the received snapshot to one or more file checksums and listing checksums of an unverified snapshot responsive to receiving a snapshot verification request, and providing an indication that the snapshot is valid responsive to determining that the one or more file checksums and the listing checksum of the received snapshot and the one or more file checksums and listing checksums of an unverified snapshot are the same. A computer program product and a computer system corresponding to the method are also disclosed.

### BRIEF DESCRIPTION OF THE DRAWINGS

FIG. 1 is a block diagram depicting one example of a snapshot verification system in accordance with some embodiments of the present invention;

FIG. 2 is a flowchart depicting one example of a snapshot verification method in accordance with at least one embodiment of the present invention;

FIG. 3 depicts an example of a filesystem description in accordance with one embodiment of the present invention; and

FIG. 4 depicts a block diagram of one example of a computer, in accordance with some embodiments of the present invention.

### DETAILED DESCRIPTION

Existing snapshot implementations do not to guarantee the integrity of a snapshot. A snapshot could reveal a defect in a system, which could be detrimental to a user who is dependent on the integrity of the filesystem. In a scenario where strict audit requirements are in place, a user could manipulate the snapshot to hide the revealed defect. For example, a user could flip a bit on a failing disk to cover up the defect in the snapshot of the filesystem. Consequently, the ability to verify the validity of a snapshot may be beneficial.

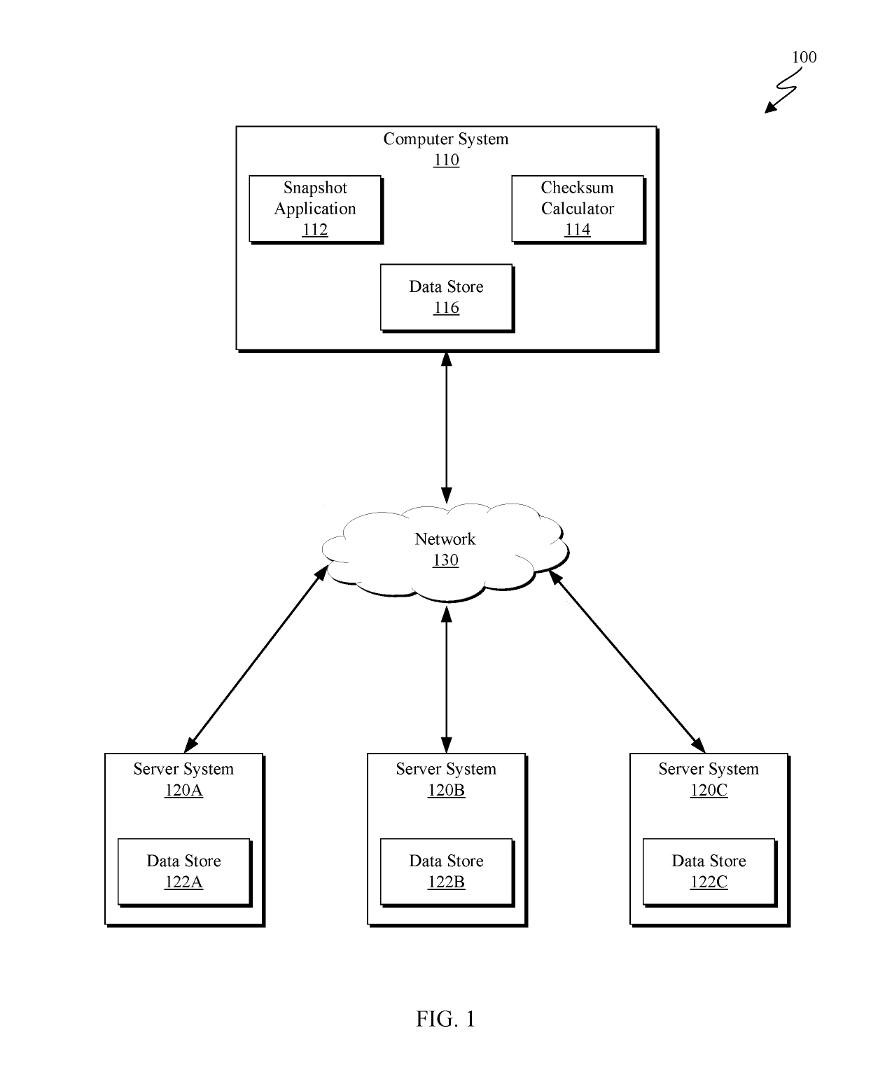

FIG. 1 is a block diagram depicting one example of a snapshot verification system 100 in accordance with some embodiments of the present invention. As depicted, snapshot verification system 100 includes computer system 110, server systems 120, and network 130. Snapshot verification system 100 is an example of a system which may be capable

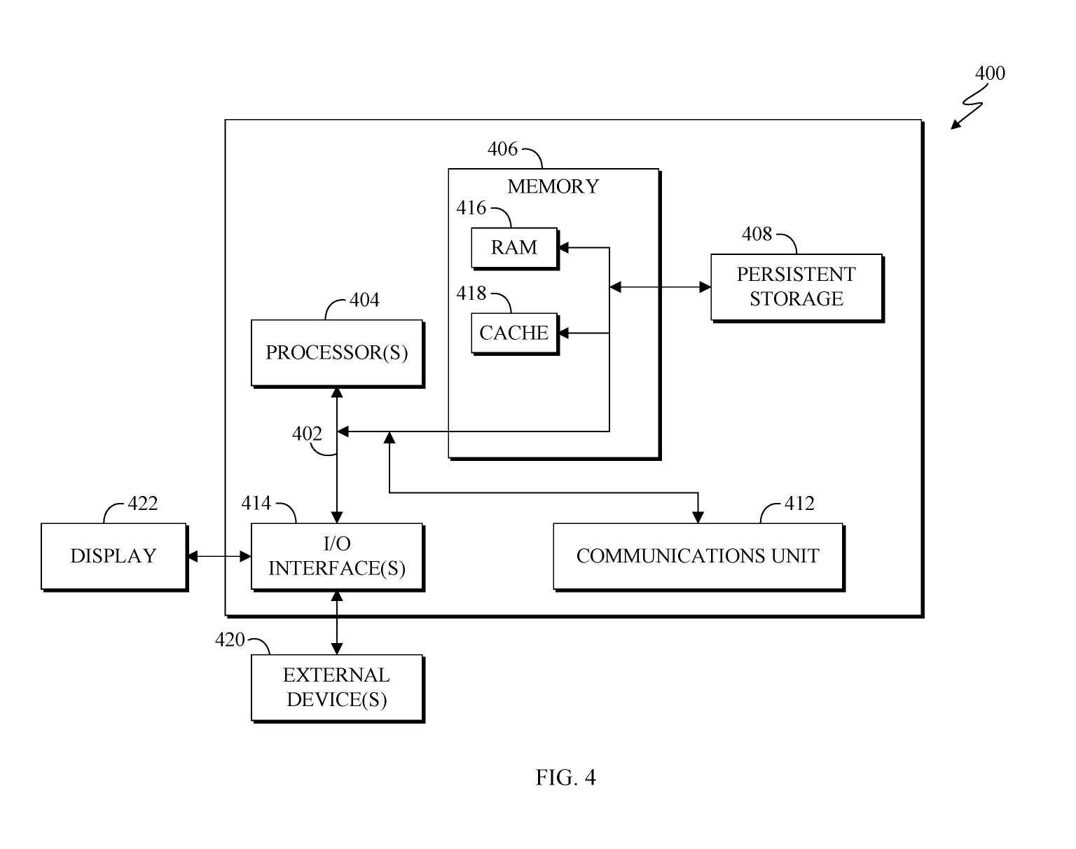

Computer system 110 and server systems 120 can each be a desktop computer, a laptop computer, a specialized computer server, or any other computer system known in the art. In some embodiments, computer system 110 and server systems 120 each represent a computer system utilizing clustered computers and components to act as a single pool of seamless resources. In general, computer system 110 and server systems 120 are each representative of any electronic device, or combination of electronic devices, capable of executing machine-readable program instructions, as described in greater detail with regard to FIG. 4.

As depicted, computer system 110 includes a snapshot application 112, a checksum calculator 114, and a data store 116. Snapshot application 112 may be configured to take a snapshot of a filesystem associated with computer system 110 or any of the server systems 120. In some embodiments, snapshot application 112 is configured to request a read only copy of data on server system 120. In other embodiments, such as embodiments where logical volume managers are implemented, snapshot application 112 is configured to create writable snapshots. In these embodiments, a parent snapshot is created encompassing all the data of interest. Any time a file within the data of interest is opened for editing, a snapshot is created depicting the filesystem before the file was modified. The parent snapshot is updated to reflect the most recent snapshot taken of the filesystem. Snapshots created by snapshot application 112 may be stored in data store 116. In some embodiments, a snapshot created by snapshot application 112 is provided to checksum calculator 114.

Checksum calculator 114 may be configured to receive a snapshot from snapshot application 112. In some embodiments, checksum calculator 114 is configured to create checksums of the data and metadata associated with all elements included in the snapshot. A checksum (or hash sum) is a small-size datum from a block of digital data used to detect errors which may have been introduced during transmission or storage. The checksums may be stored together with the snapshot in data store 116. In some embodiments, checksum calculator 114 is further configured to create a master checksum over all descriptions of elements in a snapshot and store the master checksum along with a snapshot description in data store 116. Checksum calculator 114 may be configured to execute a checksum algorithm to create checksum bits, such as a longitudinal parity check, a modular sum, Fletcher's checksum, Adler-32, and a cyclic redundancy check.

Data store 116 may store snapshots and checksums received from snapshot application 112 and checksum calculator 114. Data store 116 may be any non-volatile storage media known in the art. For example, data store 116 can be implemented with a tape library, optical library, one or more independent hard disk drives, or multiple hard disk drives in a redundant array of independent disks (RAID). Similarly, data on data store 116 may conform to any suitable storage architecture known in the art, such as a file, a relational database, an element-oriented database, and/or one or more tables.

As depicted, each server system 120 comprises a data store 122. Data store 122 may be configured to store data corresponding to a filesystem hosted on server system 120. Data store 122 may be any non-volatile storage media known in the art. For example, data store 122 can be implemented with a tape library, optical library, one or more independent hard disk drives, or multiple hard disk drives in a redundant array of independent disks (RAID). Similarly, data on data store 122 may conform to any suitable storage architecture known in the art, such as a file, a relational database, an element-oriented database, and/or one or more tables.

Network 130 can be, for example, a local area network (LAN), a wide area network (WAN) such as the Internet, or a combination of the two, and include wired, wireless, or fiber optic connections. In general, network 130 can be any combination of connections and protocols that will support communications between server system 120 and computer system 110 in accordance with an embodiment of the present invention.

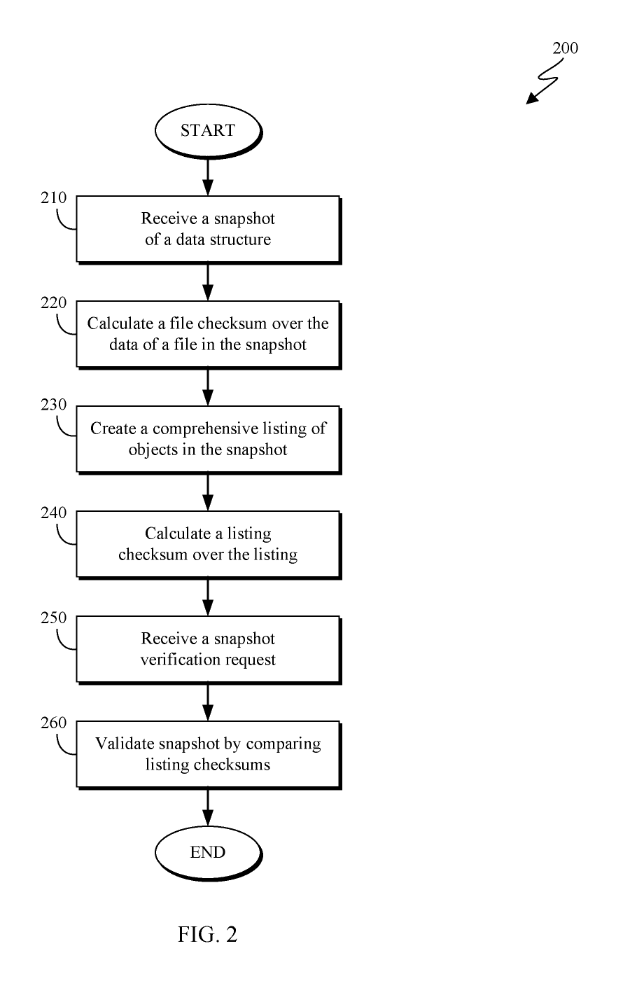

FIG. 2 is a flowchart depicting one example of a snapshot verification method 200 in accordance with at least one embodiment of the present invention. As depicted, snapshot verification method 200 includes receiving (210) a snapshot of a set of data, calculating (220) a file checksum over the data of a file in the snapshot, creating (230) a comprehensive listing of elements in the snapshot, calculating (240) a listing checksum over the listing, receiving (250) a snapshot verification request, and validating (260) the snapshot using the corresponding checksums. Snapshot verification method 200 may enable a user to determine whether a snapshot has been altered or tampered with.

Receiving (210) a snapshot of a set of data may include receiving a snapshot produced by a snapshot application such as snapshot application 112 discussed with respect to FIG. 1. The set of data to which the snapshot corresponds may be a filesystem, a dataset, or any other data structure corresponding to a computer system. The received snapshot may be a read-only depiction of the state of the set of data at a specific time. In other embodiments, the received snapshot is a writable snapshot corresponding to the set of data. The received snapshot may correspond to a set of data comprising one or more files.

Calculating (220) a file checksum corresponding to the data of a file in the snapshot may include using a checksum algorithm to provide a checksum corresponding to the file. The checksum algorithm may be configured to output a significantly different value if an input has been changed even slightly. In some embodiments, cryptographic hash functions may be used to calculate the file checksum. The calculated file checksum may be stored along with the snapshot in a data store.

Creating (230) a file listing of elements in the snapshot may include identifying elements and files depicted in the received snapshot. In at least one embodiment, the listing comprises all files in the snapshot as well as any checksums associated with the files. The listing may be stored in a data store along with the snapshots and checksums. In some embodiments, the file listing is stored separately from the snapshots and checksums.

Calculating (240) a listing checksum corresponding to the listing may include using a checksum algorithm to provide a checksum corresponding to the listing. The checksum algorithm may be the same algorithm as used previously to calculate a file checksum. In some embodiments, the listing checksum is stored with the snapshot description.

Receiving (250) a snapshot verification request may include receiving a request from a user to verify the validity of the snapshot. In some embodiments, receiving (250) a snapshot verification request may further include receiving an unverified snapshot to be validated against the created snapshot. The unverified snapshot may include some or all of the elements included in the created snapshot.

Validating (260) the snapshot using the corresponding checksums may include calculating a checksum corresponding to each file in the unverified snapshot. The checksums corresponding to the files in the unverified snapshot may then be compared to the previously calculated checksums corresponding to the files in the original snapshot. Additionally, validating (260) the snapshot may include creating a user snapshot listing of all elements in the unverified snapshot, including the individual file checksums. In some embodiments, the checksum of the user snapshot listing is then compared to the checksum stored with the snapshot. If either of the above snapshots do not match, the unverified snapshot is deemed invalid. If all of the compared snapshots match, then the snapshot is validated. Validating (260) the snapshot may further include providing a notification to a user indicating whether or not the snapshot has been deemed valid.

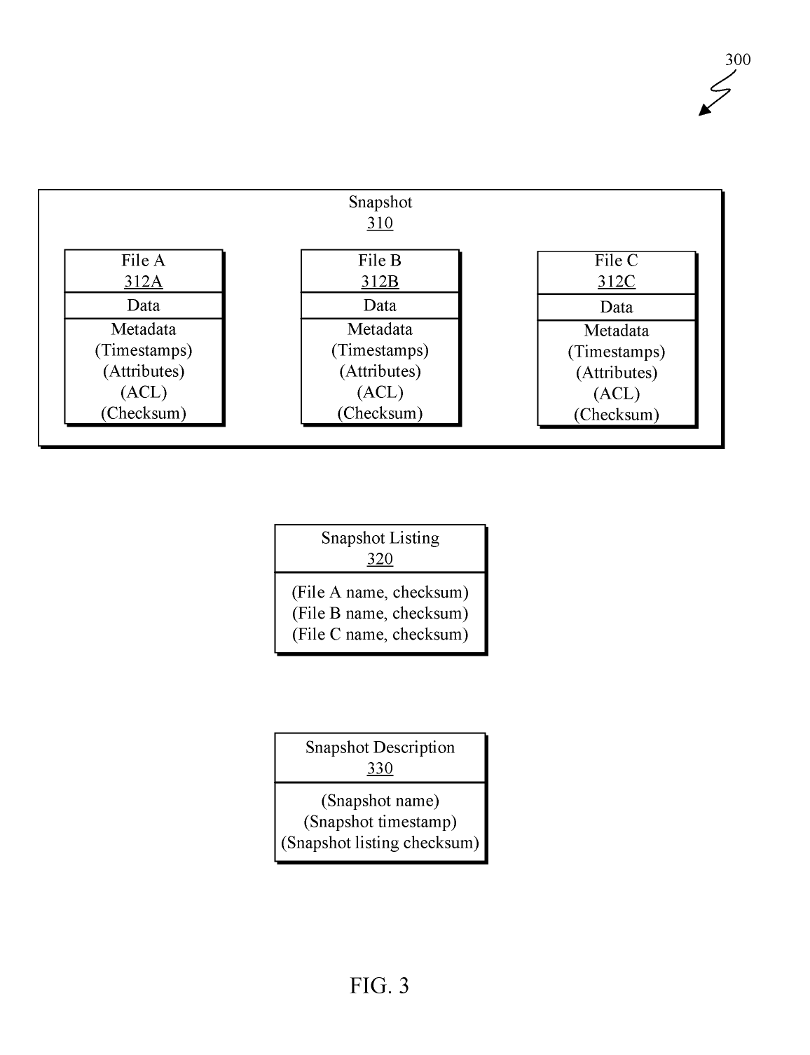

FIG. 3 depicts an example of a filesystem description 300 and associated stored snapshot information in accordance with one embodiment of the present invention. As depicted, filesystem description 300 includes snapshot 310, files 312, a snapshot listing 320, and a snapshot description 330. The filesystem description 300 may correspond to a snapshot 300 and any associated information that may be stored to be utilized to validate a snapshot.

Files 312 may be read only versions of three files (312A, 312B, 312C) as they were at the time the snapshot was created. As depicted, stored with each file 312 is the name of the file, the data associated with each file, and the corresponding metadata for each file. In the depicted embodiment, the stored relevant metadata includes timestamps corresponding to the file (such as a creation time, time of last edit, etc.), attributes corresponding to the file (size, format, etc.), the ACL of the file, and a calculated checksum associated with the file. When comparing snapshots, the checksum associated with file 312A will be compared to the checksum associated with the corresponding file in another file to determine if the snapshot has been altered.

Snapshot listing 320 may be a listing of all of the files depicted in the snapshot. As depicted, snapshot listing 320 includes an entry corresponding to each of the files 312. Each entry includes the name of one of the files 312, as well as the checksum associated with each file. Snapshot listing 320 provides a condensed version of the information available via the snapshot 300.

Snapshot description 330 may be an information file corresponding to a snapshot of interest, in this case snapshot 310. As depicted, snapshot description 330 includes the name of the snapshot of interest, a timestamp corresponding to the creation of the snapshot of interest, and a checksum associated with the corresponding snapshot listing. The snapshot listing checksum can be utilized to determine whether the snapshot listing has been altered to hide a defect.

FIG. 4 depicts a block diagram of components of computer 400 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

As depicted, the computer 400 includes communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media.

One or more programs may be stored in persistent storage 408 for access and/or execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 414 allows for input and output of data with other devices that may be connected to computer 400. For example, I/O interface 414 may provide a connection to external devices 420 such as a keyboard, keypad, a touch screen, and/or some other suitable input device. External devices 420 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 408 via I/O interface(s) 414. I/O interface(s) 414 also connect to a display 422.

Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computer/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computer/processing device receives computer readable program instructions from the network and forwards the computer readable program instructions for storage in a computer readable storage medium within the respective computer/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or element code written in any combination of one or more programming languages, including an element oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving a snapshot comprising one or more files;
calculating one or more file checksums for the files in the snapshot;
creating a listing of elements in the snapshot;
calculating a listing checksum corresponding to the listing of elements in the snapshot;
comparing the one or more file checksums and the listing checksum of the received snapshot to one or more file checksums and listing checksums of an unverified snapshot responsive to receiving a snapshot verification request; and
providing an indication that the snapshot is valid responsive to determining that the one or more file checksums and the listing checksum of the received snapshot and the one or more file checksums and listing checksums of an unverified snapshot are the same.

2. The method of claim 1, further comprising:
receiving an unverified snapshot comprising one or more files.

3. The method of claim 2, further comprising:
calculating one or more file checksums corresponding to one or more of the files in the unverified snapshot;
creating a listing of elements in the unverified snapshot; and
calculating a listing checksum corresponding to the listing of elements in the unverified snapshot.

4. The method of claim 3, further comprising:
providing an indication that the snapshot is not valid responsive to determining the one or more file checksums and the listing checksum of the received snapshot and the one or more file checksums and listing checksums of an unverified snapshot are not the same.

5. The method of claim 4, wherein a listing of elements in the snapshot comprises files within the snapshot as well as checksums associated with the files in the snapshot.

6. The method of claim 1, further comprising:
storing the one or more file checksums, the snapshot listing, and the listing checksum in a data store.

7. The method of claim 1, wherein calculating one or more file checksums corresponding to one or more of the files in the snapshot occurs responsive to one or more of the files in the snapshot being edited.

8. A computer program product comprising:
one or more computer readable storage media and program instructions stored on the one or more computer readable storage media, the program instructions comprising instructions to:
receive a snapshot comprising one or more files;
calculate one or more file checksums for the files in the snapshot;
create a listing of elements in the snapshot;
calculate a listing checksum corresponding to the listing of elements in the snapshot;
compare the one or more file checksums and the listing checksum of the received snapshot to one or more file checksums and listing checksums of an unverified snapshot responsive to receiving a snapshot verification request; and
provide an indication that the snapshot is valid responsive to determining that the one or more file checksums and the listing checksum of the received snapshot and the one or more file checksums and listing checksums of an unverified snapshot are the same.

9. The computer program product of claim 8, further comprising instructions to:
receive an unverified snapshot comprising one or more files.

10. The computer program product of claim 9, further comprising instructions to:
calculate one or more file checksums corresponding to one or more of the files in the unverified snapshot;
create a listing of elements in the unverified snapshot; and
calculate a listing checksum corresponding to the listing of elements in the unverified snapshot.

11. The computer program product of claim 10, further comprising instructions to:
providing an indication that the snapshot is not valid responsive to determining the one or more file checksums and the listing checksum of the received snapshot and the one or more file checksums and listing checksums of an unverified snapshot are not the same.

12. The computer program product of claim 11, wherein a listing of elements in the snapshot comprises files within the snapshot as well as checksums associated with the files in the snapshot.

13. The computer program product of claim 8, further comprising instructions to:
store the one or more file checksums, the snapshot listing, and the listing checksum in a data store.

14. The computer program product of claim 8, wherein calculating the one or more file checksums corresponding to one or more of the files in the snapshot occurs responsive to one or more of the files in the snapshot being edited.

15. A computer system comprising:
one or more computer processors;
one or more computer-readable storage media;
program instructions stored on the computer-readable storage media for execution by at least one of the one or more processors, the program instructions comprising instructions to:
receive a snapshot comprising one or more files;
calculate one or more file checksums for the files in the snapshot;
create a listing of elements in the snapshot;
calculate a listing checksum corresponding to the listing of elements in the snapshot;
compare the one or more file checksums and the listing checksum of the received snapshot to one or more file checksums and listing checksums of an unverified snapshot responsive to receiving a snapshot verification request; and
provide an indication that the snapshot is valid responsive to determining that the one or more file checksums and the listing checksum of the received snapshot and the one or more file checksums and listing checksums of an unverified snapshot are the same.

16. The computer system of claim 15, further comprising instructions to:
receive an unverified snapshot comprising one or more files.

17. The computer system of claim 16, further comprising instructions to:
calculate one or more file checksums corresponding to one or more of the files in the unverified snapshot;
create a listing of elements in the unverified snapshot; and
calculate a listing checksum corresponding to the listing of elements in the unverified snapshot.

18. The computer system of claim 17, further comprising instructions to:
providing an indication that the snapshot is not valid responsive to determining the one or more file checksums and the listing checksum of the received snapshot and the one or more file checksums and listing checksums of an unverified snapshot are not the same.

19. The computer system of claim 15, further comprising instructions to:
store the one or more file checksums, the snapshot listing, and the listing checksum in a data store.

20. The computer system of claim 15, wherein calculating the one or more file checksums corresponding to one or more of the files in the snapshot occurs responsive to one or more of the files in the snapshot being edited.
